(19) United States
(12) Patent Application Publication
(10) Pub. No.: US 2003/0126602 A1
(43) Pub. Date: Jul. 3, 2003

(54) Method for selecting channel in digital television

(75) Inventors: Yeon-Taek Han, Suwon-si (KR); Young-Hwan Pan, Suwon-si (KR)

Correspondence Address: SUGHRUE MION, PLLC, 2100 PENNSYLVANIA AVENUE, N.W., WASHINGTON, DC, 20037, US

(73) Assignee: Samsung Electronics Co., Ltd.

(21) Appl. No.: 10/259,295

(22) Filed: Sep. 30, 2002

(30) Foreign Application Priority Data
Dec. 29, 2001 (KR) 2001-88230

(51) Int. Cl. H04N 7/00; H04N 5/445; G06F 13/00

(52) U.S. Cl. 725/38; 348/39

(57) ABSTRACT

There is provided a channel selection method for a digital television, through which a current channel can be easily changed into a channel belonging to the same category as the current channel belongs to. The channel selection method includes (a) generating a channel selection command in response to a user's operation; (b) displaying information about channels, on which programs belonging to the same category as a current channel are broadcasted, on a television screen in response to the channel selection command; (c) selecting a desired channel referring to the information about the channels; and (d) displaying a program which is broadcasted on the selected channel.

### CROSS-REFERENCE TO RELATED APPLICATIONS

This application is based upon and claims priority from Korean Patent Application No. 01-88230 filed Dec. 29, 2001, the contents of which are incorporated herein by reference.

### BACKGROUND OF THE INVENTION

1. Field of the Invention

The present invention relates to a method for selecting a channel in a digital television, and more particularly, to a channel selection method for a digital television, through which a current channel can be easily changed to a channel belonging to the same category as the current channel.

2. Description of the Related Art

Generally, an analog mode and a digital mode are used in television (TV). Conventional TVs usually use an analog mode in which a radio wave signal is sequentially processed over time. As a result, picture and sound quality is not satisfactory, and the number of channels is limited.

Conversely, digital TVs are the most advanced TVs that convert an analog signal into a digital signal and control the signal using a computer circuit. Digital TVs remove noise such as interruption of different radio waves, provide users with various kinds of information and programs, and reproduce a variety of up-to-date images.

On the basis of the number of pixels displayed on a screen, digital TVs provide an image in eighteen different formats from a standard definition TV (SDTV) having a resolution of 640 by 480, which is the same level as the National Television System Committee (NTSC) format, to a high definition TV (HDTV) having a resolution of 1920 by 1080 which is seven times greater than SDTV.

The most distinguishing feature of digital broadcasting through digital TVs is multichannel support. Digital TVs support at least 200 through 350 channels. Several hundreds of channels confuse TV viewers in selecting a channel. To overcome this problem, an electronic program guide (EPG) is used. An EPG performs a function of informing viewers of what program is broadcasted in what channel.

FIG. 1 is a flowchart of a usual method for selecting a channel in a digital TV using an EPG. Referring to FIG. 1, it is determined whether a viewer wants to select a channel in step 101. If it is determined that the viewer wants to select a channel in step 101, the EPG is performed in step 102. If a plurality of categories are displayed on a TV screen as the result of performing the EPG, the viewer selects a category to which a desired program belongs in step 103. For example, when the viewer wants to watch sports, a sports category is selected among the plurality of categories. If the viewer selects a category, a plurality of sub-categories corresponding to the selected category are displayed. For example, if the sports category is selected, subcategories such as football, baseball, volleyball, and basketball are displayed. If such sub-categories are displayed on the screen, the viewer selects a subcategory to which the desired program belongs in step 104. For example, if the viewer wants to watch a football game, he/she selects a sub-category including a channel relaying a football game. Each sub-category includes a plurality of channels. If the viewer selects one among the plurality of channels in step 105, he/she can watch a program provided on the selected channel in step 106.

According to the above-described method, when the viewer wants to select another channel which belongs to the same category as the current program that he/she is watching, he/she needs to go through several steps again even if the channel belongs to the same category.

### SUMMARY OF THE INVENTION

To solve the above-described problems, it is an object of the present invention to provide a method for changing a current channel, on which a viewer watches a program on a digital television (TV), into another channel which belongs to the same category as the current program or is related to the current channel.

To achieve the above object of the present invention, in one embodiment, there is provided a method for selecting a channel in a digital television, which includes the steps of: (a) generating a channel selection command in response to a user's operation; (b) displaying information about channels, on which programs belonging to the same category as a current channel are broadcasted, on a television screen in response to the channel selection command; (c) selecting a desired channel referring to the information about the channels; and (d) displaying a program which is broadcasted on the selected channel.

In another embodiment, there is provided a method for selecting a channel in a digital television, which includes the steps of: (a) generating a channel selection command in response to a user's operation; (b) detecting a category ID of a current program in response to the channel selection command; (c) forming a list of channels, which belong to the same category as the current program, based on the category ID; (d) displaying the list on a television screen; (e) selecting a desired channel by referring to the list of channels; and (f) displaying a program which is broadcasted on the selected channel.

### BRIEF DESCRIPTION OF THE DRAWINGS

The above object and advantages of the present invention will become more apparent by describing in detail preferred embodiments thereof with reference to the attached drawings in which:

FIG. 1 is a flowchart of a usual method for selecting a channel in a digital television (TV) using an electronic program guide (EPG);

FIG. 2 is a block diagram of a digital TV system according to a preferred embodiment of the present invention;

FIG. 3 is a flowchart of a method for selecting a channel in a digital TV according to a preferred embodiment of the present invention;

FIG. 4 is a detailed flowchart of step 204 shown in FIG. 3; and

FIGS. 5 through 7 are diagrams showing screens on which a channel is selected according to the preferred embodiment of the present invention.

### DETAILED DESCRIPTION OF THE INVENTION

Hereinafter, preferred embodiments of the present invention will be described in detail with reference-to the -attached-drawings.

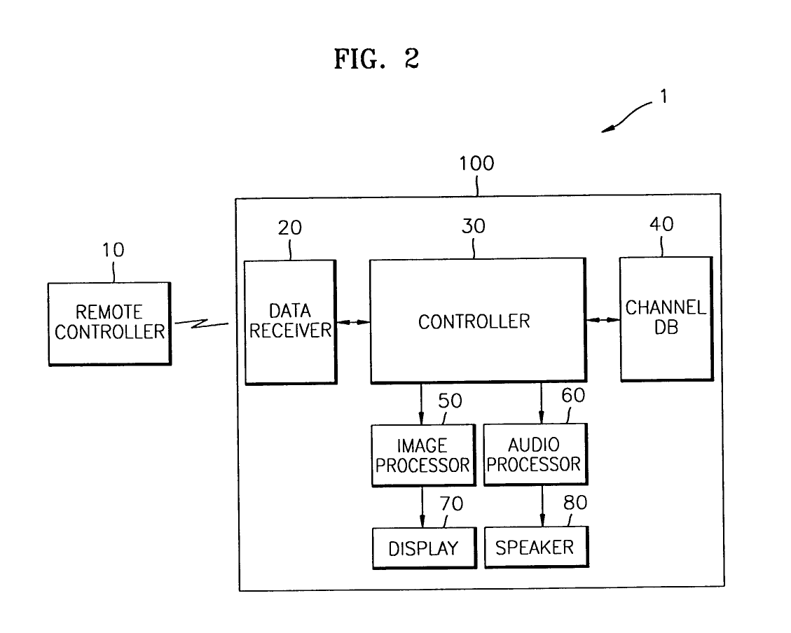

FIG. 2 is a block diagram of a digital television (TV) system 1 according to a preferred embodiment of the present invention. Referring to FIG. 2, the digital TV system 1 includes a digital TV 100 and a remote controller 10 for remotely controlling the operation of the digital TV 100. The digital TV 100 includes a data receiver 20, a controller 30, a channel database (DB) 40, an image processor 50, an audio processor 60, a display 70, and a speaker 80.

The data receiver 20 receives a control signal transmitted from the remote controller 10 and transmits it to the controller 30. The controller 30 entirely controls the operation of the digital TV 100. The channel DB 40 stores information on various channels, which is displayed on the digital TV 100. The information stored in the channel DB 40 is based on EPG information and includes a category ID of each program broadcasted on each channel.

The controller 30 receives the control signal transmitted from the remote controller 10 through the data receiver 20 and controls the image processor 50 and the audio processor 60 to process relevant image data and audio data, respectively, based on the information stored in the channel DB 40. The data processed through the image processor 50 is output through the display 70, and the data processed through the audio processor 60 is output through the speaker 80. The following description concerns a method for selecting a channel in the digital TV 100 having the above structure.

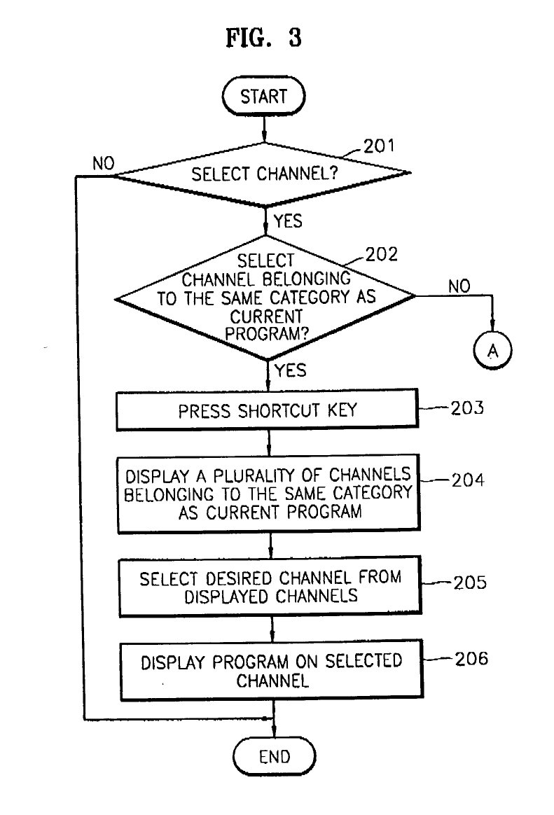

FIG. 3 is a flowchart of a method for selecting a channel in a digital TV according to a preferred embodiment of the present invention. Referring to FIG. 3, it is determined whether a viewer wants to select a channel in step 201. If it is determined that the viewer wants to select in step 201, it is determined whether the viewer wants to select a channel belonging to the same category as a current program that he/she is watching in step 202.

If the viewer wants to watch another program belonging to the same category as the current program, the viewer presses a shortcut key which is provided on a remote controller for channel selection in step 203. If a predetermined shortcut key is pressed by the viewer, a plurality of channels, on which programs belonging to the same category as the current program are broadcasted, are displayed in step 204. The viewer selects a desired channel from the displayed channels in step 205 and watches a program broadcasted on the selected channel in step 206.

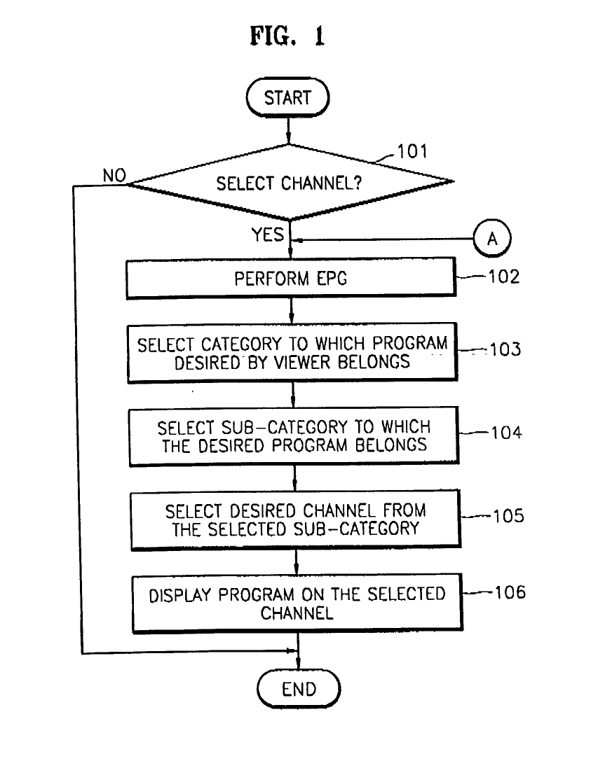

If the viewer wants to watch another program belonging to a different category from the current program in step 202, the procedure goes to the step A shown in FIG. 1 to perform channel selection using an EPG.

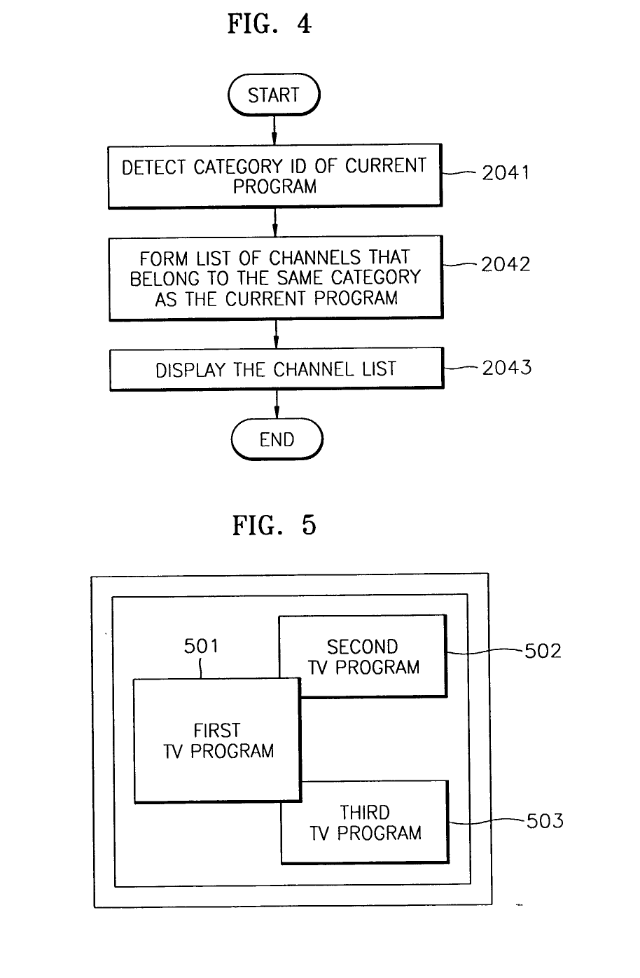

FIG. 4 is a detailed flowchart of step 204 shown in FIG. 3. Referring to FIG. 4, in order to display the channels on which programs belonging to the same category as the current program are broadcasted, a category ID of the current program is detected in step 2041. The category ID of the program is contained in the EPG information stored in the channel DB 40.

Next, a list of channels that belong to the same category as the current program is formed based on the detected category ID in step 2042. The channel list is displayed on the TV screen in step 2043.

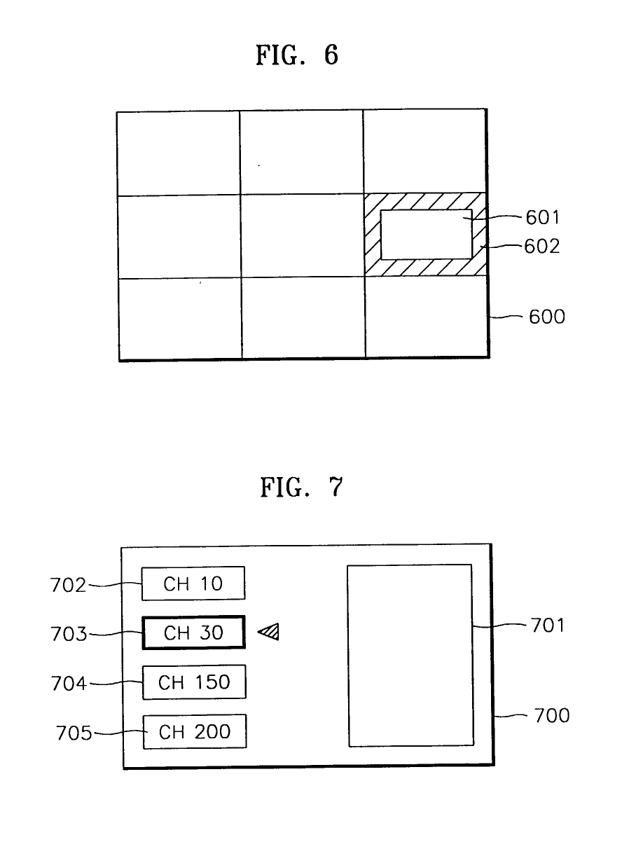

FIGS. 5 through 7 are diagrams showing screens on which a channel is selected according to the preferred embodiment of the present invention. FIG. 5 shows an example in which channels that are related to a current program or belong to the same category as the current program are displayed in picture-in-picture (PIP) form or twin picture form.

Referring to FIG. 5, a first TV program is displayed on a first screen 501. Second and third TV programs are displayed on second and third screens 502 and 503, respectively. Here, the first TV program may be a program that a user is currently watching, and the second and third TV programs may be programs belonging to the same category as the current program. Alternatively, all of the first through third TV programs may be programs belonging to the same category as a current program. Whenever a command for selecting a channel is transmitted from a remote controller to a digital TV by a user, each channel in a channel list is tuned. As a result, one among the programs displayed on the first through third screens 501 through 503 is selected and displayed on the first screen 501. With such method, a desired channel is selected.

FIG. 6 shows an example in which channels that are related to a current program or belong to the same category as the current program are displayed in multi-PIP form. Referring to FIG. 6, in a case where a user wants to select another program belonging to the same category as a current program, a multi-PIP screen 600 is displayed on a digital TV screen. Whenever a command for selecting a channel is transmitted from a remote control to the digital TV by the user, each channel in a channel list is tuned, and one screen in the multi-PIP screen is selected. For example, if a screen 601 is selected, the screen 601 is marked with a highlight 602.

FIG. 7 shows an example in which channels that are related to a current program or belong to the same category as the current program are displayed in On Screen Display (OSD) form. OSD is a function of directly displaying information about a monitor, information which a user requires or needs to know.

Referring to FIG. 7, in a case where a user wants to select another program belonging to the same category as a current program, an OSD screen 700 is displayed on a digital TV screen. On the OSD screen 700 is displayed a list of channels 702 through 705, which is formed according to the method shown in FIG. 4, in text form. Whenever a command for selecting a channel is transmitted from a remote control to the digital TV by the user, each channel in the channel list is tuned and selected. A selected channel may be marked with an arrow, as shown in FIG. 7. A program of the selected channel is displayed on a small screen 701 included in the OSD screen 700. As a result, the user can select a desired channel while watching a program that is displayed on the screen 701 in response to channel selection from the channels 702 through 705 in the list.

In addition to the display methods shown in FIGS. 5 through 7, the present invention may use a method in which when a user operates a particular key for channel selection, channels belonging to the same category as a currently set channel are sequentially displayed for a predetermined period of time (for example, two seconds) so that the user can select a desired channel.

As described above, according a channel selection method of the present invention, it is easy to change a current channel into another channel which belongs to the same category as a program broadcasted on the current channel.

Further, the present invention can be realized as a code which is recorded on a computer readable recording medium and can be read by a computer. The computer readable recording medium may be any type on which data which can be read by a computer can be recorded, for example, a ROM, a RAM, a CD-ROM, a magnetic tape, a floppy disc, or an optical data storage device. The present invention can also be realized as carrier waves (for example, transmitted through the Internet). Alternatively, computer readable recording media are distributed among computer systems connected through a network so that the present invention can be realized as a code which is stored in the recording media and can be read and executed in the computers.

What is claimed is:

1. A method for selecting a channel in a digital television, comprising steps of:
(a) generating a channel selection command in response to a user's operation;
(b) displaying information about channels, on which programs belonging to a same category as a current channel are broadcasted, on a television screen in response to the channel selection command;
(c) selecting a desired channel by referring to the information about the channels; and
(d) displaying a program which is broadcasted on the selected channel.

2. The method of claim 1, wherein step (b) comprises steps of:
(b-1) detecting a category ID of a current program;
(b-2) forming a list of channels, which belong to the same category as the current program, based on the category ID; and
(b-3) displaying the list on the television screen.

3. The method of claim 1, wherein in step (b) the information about the channels is displayed in one form selected from a group consisting of picture-in-picture (PIP) form, twin picture form, multi-PIP form, and on screen display (OSD) form.

4. The method of claim 2, wherein the category ID is based on electronic program guide (EPG) information.

5. A method for selecting a channel in a digital television, comprising steps of:
(a) generating a channel selection command in response to a user's operation;
(b) detecting a category ID of a current program in response to the channel selection command;
(c) forming a list of channels, which belong to a same category as the current program, based on the category ID;
(d) displaying the list on a television screen;
(e) selecting a desired channel by referring to the list of channels; and
(f) displaying a program which is broadcasted on the selected channel.

6. The method of claim 5, wherein in step (d) the list of channels is displayed in one form selected from a group consisting of picture-in-picture (PIP) form, twin picture form, multi-PIP form, and on screen display (OSD) form.

7. The method of claim 5, wherein the category ID is based on electronic program guide (EPG) information.

8. A computer-readable recording medium for recording a computer program code for enabling a computer to provide a service of selecting a channel in a digital television, the service comprising steps of:
(a) generating a channel selection command in response to a user's operation;
(b) displaying information about channels, on which programs belonging to a same category as a current channel are broadcasted, on a television screen in response to the channel selection command;
(c) selecting a desired channel by referring to the information about the channels; and
(d) displaying a program which is broadcasted on the selected channel.

9. The computer-readable recording medium of claim 8, wherein step (b) comprises steps of:
(b-1) detecting a category ID of a current program;
(b-2) forming a list of channels, which belong to the same category as the current program, based on the category ID; and
(b-3) displaying the list on the television screen.

10. The computer-readable recording medium of claim 8, wherein in step (b) the information about the channels is displayed in one form selected from a group consisting of picture-in-picture (PIP) form, twin picture form, multi-PIP form, and on screen display (OSD) form.

11. The computer-readable recording medium of claim 9, wherein the category ID is based on electronic program guide (EPG) information.

12. A computer-readable recording medium for recording a computer program code for enabling a computer to provide a service of selecting a channel in a digital television, the service comprising steps of:
(a) generating a channel selection command in response to a user's operation;
(b) detecting a category ID of a current program in response to the channel selection command;
(c) forming a list of channels, which belong to a same category as the current program, based on the category ID;
(d) displaying the list on a television screen;
(e) selecting a desired channel by referring to the list of channels; and
(f) displaying a program which is broadcasted on the selected channel.

13. The computer-readable recording medium of claim 12, wherein in step (d) the list of channels is displayed in one form selected from a group consisting of picture-in-picture (PIP) form, twin picture form, multi-PIP form, and on screen display (OSD) form.

14. The computer-readable recording medium of claim 12, wherein the category ID is based on electronic program guide (EPG) information.
